(19) United States
(12) Patent Application Publication
(10) Pub. No.: US 2011/0242031 A1
(43) Pub. Date: Oct. 6, 2011

(54) DISPLAY DEVICE WITH TOUCH FUNCTION AND 2D SENSING METHOD THEREOF

(75) Inventors: Wen-Hsin Cheng, Hsinchu City (TW); Feng-Jung Kuo, Hsinchu County (TW); Chiu-Huang Huang, Hsinchu County (TW); Wen-Hao Yu, Hsinchu City (TW)

(73) Assignee: NOVATEK MICROELECTRONICS CORP., Hsinchu (TW)

(21) Appl. No.: 13/076,454

(22) Filed: Mar. 31, 2011

(30) Foreign Application Priority Data
Apr. 2, 2010 (TW) 99110384

(51) Int. Cl. G06F 3/041

(52) U.S. Cl. 345/173

(57) ABSTRACT

A display device with a touch function is provided. The display device includes a display panel and a touch panel. The display panel has a plurality of image scan lines, and the image scan lines are respectively activated by a plurality of scan signals generated by a gate driver according to a time sequence. The touch panel has a plurality of touch scan lines and a plurality of touch sensing lines, wherein the touch scan lines and the touch sensing lines are disposed crossing each other for sensing a touched position. The gate driver also provides a plurality of touch scan signals to the touch scan lines according to a time sequence.

### CROSS-REFERENCE TO RELATED APPLICATION

This application claims the priority benefit of Taiwan application serial no. 99110384, filed on Apr. 2, 2010. The entirety of the above-mentioned patent application is hereby incorporated by reference herein and made a part of this specification.

### BACKGROUND

1. Field of the Invention

The present invention generally relates to a touch panel, and more particularly, to a touch panel driven by a gate driver of a display panel.

2. Description of Related Art

A display device is usually integrated with a touch panel in order to provide a more efficient and convenient control interface. An image displayed by a general flat panel display device is composed of a 2-dimensional (2D) pixel array, and the pixels are driven through horizontal scan lines and vertical data lines to present the correct color and gray scale.

A thin film transistor liquid crystal display (TFT-LCD) device will be described as an example. FIG. 1 is a circuit diagram of a conventional TFT-LCD device. Referring to FIG. 1, the pixel array of the display panel 100 is composed of a plurality of pixel units 106. If a color image is displayed, each pixel is further composed of three sub pixel units 106 for respectively displaying red, green, and blue colors. Each pixel unit 106 has at least one TFT as its driving switch. The gate driver 102 respectively generates the pulse-like driving signals out1, out2, out3, . . . according to a time sequence and respectively outputs the driving signals to the image scan lines.

The TFTs of the pixel units 106 connected to the image scan lines are respectively activated by the corresponding driving signals. Then, the source driver 104 respectively inputs voltages Vout corresponding to the gray scale values to the pixels to display the image. The driving technique of the TFT-LCD device should be understood by those having ordinary knowledge in the art therefore will not be described in detail herein. Any other flat panel display device is also driven through scan lines and data lines. In other words, the image scan lines thereof are controlled by the gate driver according to a time sequence.

Conventionally, the display panel is driven by its own gate driver 102, and the touch panel works separately from the display panel. Because the touch panel needs to detect any touch point and determine the position of the touch point, the touch panel detects the X-coordinate and the Y-coordinate. A conventional touch panel may be a resistive touch panel or a capacitive touch panel, and which detects a touch point and determine the position of the touch point through measurements in two directions.

Conventionally, a display panel and a touch panel work independently, and accordingly the circuits thereof are separately fabricated. How to effectively integrate a display panel and a touch panel is one of the subjects in the development of display devices.

### SUMMARY

Accordingly, the present invention is directed to a display device with a touch function and a 2-dimensional (2D) sensing method thereof, wherein the drivers of a display panel and a touch panel are partially integrated so that the circuit fabricating cost is reduced.

The present invention provides a display device with a touch function.

The display device includes a display panel and a touch panel. The display panel has a plurality of image scan lines, and the image scan lines are respectively activated by a plurality of scan signals generated by a gate driver according to a time sequence. The touch panel has a plurality of touch scan lines and a plurality of touch sensing lines, wherein the touch scan lines and the touch sensing lines are disposed crossing each other for sensing a touched position. The gate driver also provides a plurality of touch scan signals respectively to the touch scan lines according to a time sequence.

The present invention provides a display device with a touch function. The display device includes a gate driver, a display panel, and a touch panel.

The gate driver generates a plurality of pulse signals according to a time sequence. The display panel has a plurality of image scan lines, and the image scan lines are respectively and sequentially activated by the pulse signals. The touch panel has a plurality of scan sensing lines and a plurality of touch sensing lines, wherein the scan sensing lines and the touch sensing lines are disposed crossing each other. The scan sensing lines are also activated by the pulse signals.

The present invention provides a 2D sensing method of a touch panel, wherein the touch panel is stacked with a display panel, and the display panel is driven by a gate driver. The 2D sensing method includes sequentially generating a plurality of pulse signals in the gate driver and sequentially inputting the pulse signals to the touch panel to activate a plurality of touch scan lines.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional thin film transistor liquid crystal display (TFT-LCD) device.

FIG. 2 is a diagram illustrating the structure of a touch panel according to an embodiment of the present invention.

FIG. 3 is a diagram illustrating the operation mechanism of a touch panel according to an embodiment of the present invention.

FIG. 4 is a diagram illustrating the operation mechanism of integrated touch panel and display panel according to an embodiment of the present invention.

FIG. 5 is a schematic diagram of a display device with a touch function according to an embodiment of the present invention.

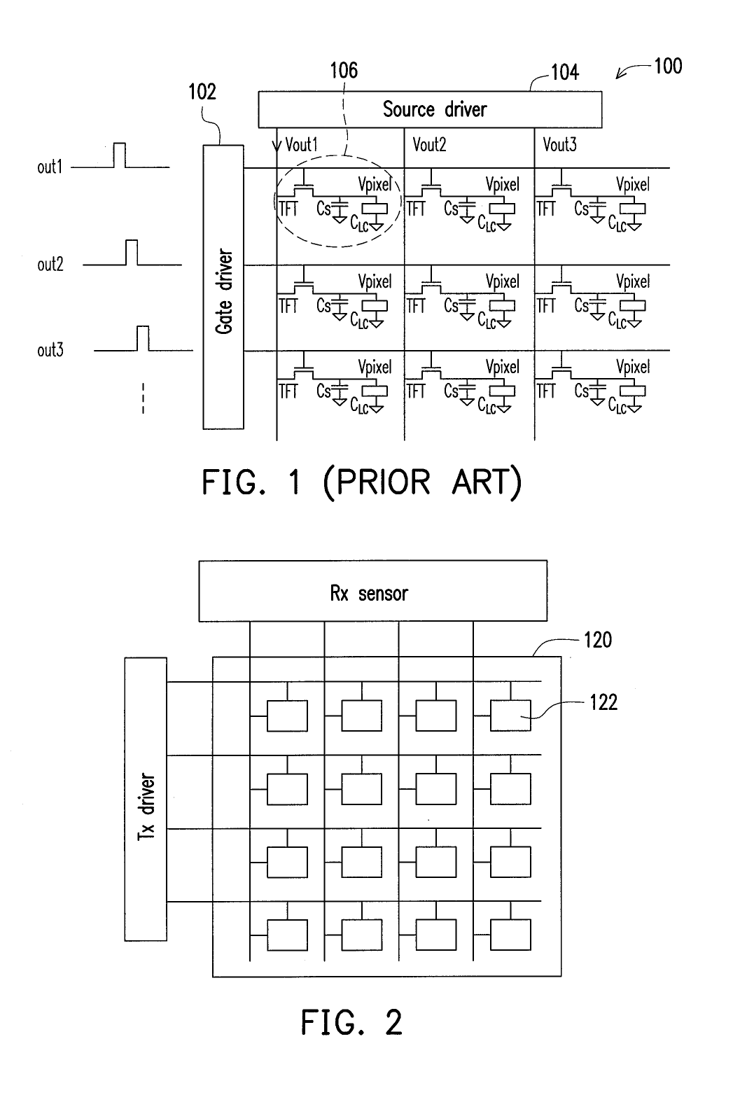

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, a display panel and a touch panel of a display device with a touch function are effectively integrated, wherein the drivers of the display panel and the touch panel are partially integrated. Namely, a gate driver and a Tx driver are integrated, wherein the Tx driver is replaced by the gate driver. Below, embodiments of the present invention will be described. However, these embodiments are not intended to limit the present invention and may be combined to create other embodiments.

In the present invention, a touch panel is integrated with a display panel having a similar driving mechanism. FIG. 2 is a diagram illustrating the structure of a touch panel according to an embodiment of the present invention. Referring to FIG. 2, the 2-dimensional (2D) sensing touch panel includes a plurality of sensing units 122, wherein the sensing units 122 are distributed within a touch area 120 of the display panel and are arranged as a 2D array. The touch panel may have different design along different touch point detection mechanism. However, in substance, the touch panel needs to detect the coordinates of a touch point. As to the touch area 120, the sensing units 122 are disposed at predetermined positions of the touch area 120 to form a 2D array.

Since each sensing unit 122 is disposed at a predetermined position, whether the corresponding position is touched can be determined by detecting whether a signal is received by the sensing unit 122.

In order to determine whether a sensing unit 122 receives a touch signal, activation signals are sequentially issued to the touch scan lines through a horizontal line extended from a Tx driver along the axis Y, wherein the activation signals may be voltage signals. A voltage signal is then received by the Rx driver. Thus, as to those touch scan lines that are activated during each time period, the corresponding sensing units 122 are detected by an Rx driver, so as to determine whether a touch signal is received and the position of the touch signal.

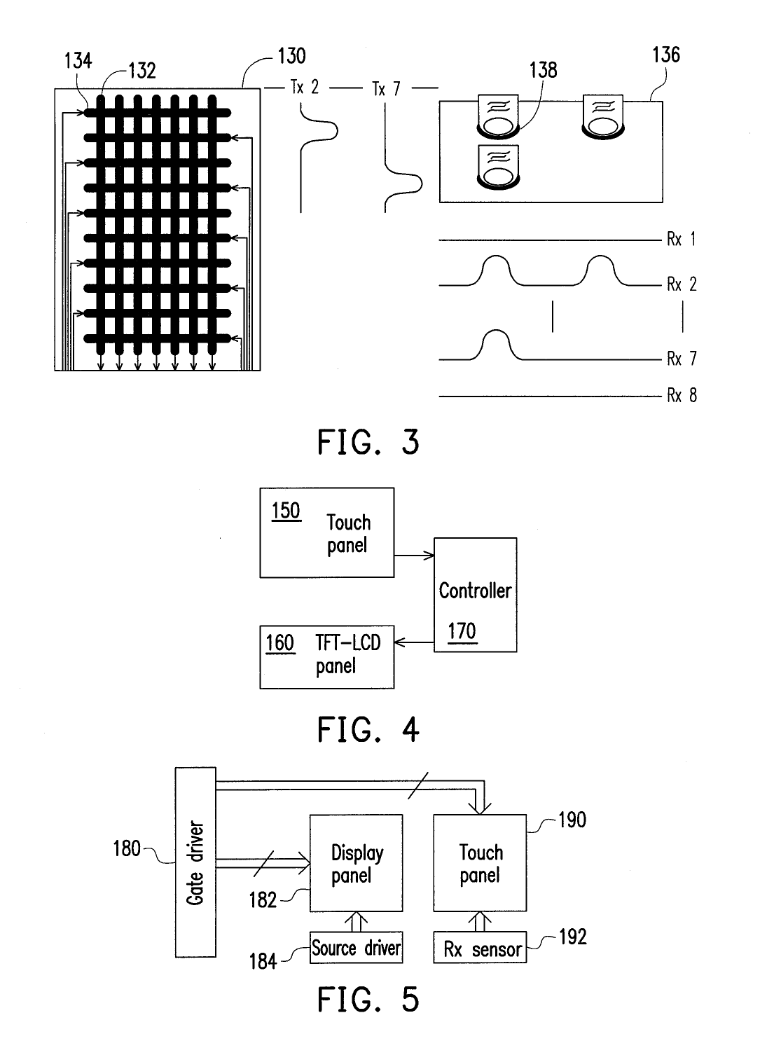

FIG. 3 is a diagram illustrating the operation mechanism of a touch panel according to an embodiment of the present invention. Referring to FIG. 3, a plurality of touch sensing lines 132 extended in one direction and a plurality of touch scan lines 134 extended in another direction are disposed on the touch panel 130, and the touch sensing lines 132 and the touch scan lines 134 are disposed crossing each other. Generally speaking, the touch scan lines 134 may be extended along the horizontal direction of the touch panel 130, and the touch sensing lines 132 may be extended along the vertical direction of the touch panel 130. The touch sensing units may be disposed on the crossing points of the touch sensing lines 132 and the touch scan lines 134. As to a touch area 136, the touch sensing units 138 form a 2D sensing point array at predetermined positions. When a touch sensing unit 138 is touched by a finger or stylus, the position of the sensing point can be determined by detecting the signal generated.

The 2D sensing method of the touch panel 130 will be described herein. A pulse signal is sequentially issued to each touch scan line 134 extended along the axis Y by a Tx driving unit, and meanwhile, the signal on each touch scan line 134 is detected by a Rx driving unit through the touch scan lines 134 extended along the axis X. Through such a technique, the touch scan lines are processed one by one until the entire touch area 136 is scanned so that the touch point can be determined.

For example, assuming that there are two touch points on the second touch scan line 134, and there is one touch point on the seventh touch scan line 134, when a signal Tx 2 is input to the second touch scan line 134, two corresponding signals are detected by the Rx driving unit, and when a signal Tx 7 is input to the seventh touch scan line 134, one corresponding signal is detected by the Rx driving unit.

The pulse-like signals Tx are in the same pattern as the scan signals of the display panel. Thus, when the display panel and the touch panel are integrated, the Tx driver and the gate driver can be integrated into a single gate driver. In other words, the scan signals of the touch panel are provided by the gate driver, and no additional Tx driver is to be disposed. The gate driver can provides the scan signals to the touch panel separately. In addition, the gate driver may also provide a portion of the scan signals provided to the display panel to the touch panel. How the gate driver serves the touch panel and the display panel is not limited to aforementioned patterns.

FIG. 4 is a diagram illustrating the operation mechanism of integrated touch panel and display panel according to an embodiment of the present invention. Referring to FIG. 4, in the display device with a touch function, the touch panel 150 and the display panel 160 are connected by a controller 170. The controller 170 sends the touch points detected by the touch panel 150 to the display panel 160 to perform the corresponding operation.

FIG. 5 is a schematic diagram of a display device with a touch function according to an embodiment of the present invention. Referring to FIG. 5, regarding the circuit layout of the display device with a touch function, the display panel 182 is still driven by a gate driver 180 and a source driver 184. As to the touch panel 190, the gate driver 180 also provides touch scan signals to the touch panel 190. The Rx sensor 192 detects whether there is any touch signal received on the touch scan lines and determines the touched position.

As described above, the present invention provides a display device with a touch function, wherein a display panel and a touch panel are integrated. The display panel has a plurality of image scan lines, and the image scan lines are respectively activated by a plurality of scan signals generated by a gate driver according to a time sequence. The touch panel has a plurality of touch scan lines and a plurality of touch sensing lines, and the touch scan lines and the touch sensing lines are disposed crossing each other for sensing a touched position. Herein, the gate driver also provides a plurality of touch scan signals to the touch scan lines according to a time sequence.

For example, when the touch scan lines are sequentially activated, signals at a plurality of sensing points on the activated touch scan lines are output through the touch sensing lines, and an Rx sensor detects and determines the positions of the touch points.

The gate driver may generate a plurality of scan signals and a plurality of touch scan signals respectively for the display panel and the touch panel.

The gate driver may generate a plurality of scan signals and select a portion of the scan signals as the touch scan signals for the touch panel.

On the other hand, the display device in the present invention has at least a gate driver, a display panel, and a touch panel. The gate driver generates a plurality of pulse signals according to a time sequence. The display panel has a plurality of image scan lines, and the image scan lines are respectively and sequentially activated by the pulse signals. The touch panel has a plurality of scan sensing lines and a plurality of touch sensing lines, and the scan sensing lines and the touch sensing lines are disposed crossing each other. The scan sensing lines are also activated by the pulse signals.

The 2D sensing method in the present invention can be applied to a display device with integrated touch panel and display panel, wherein the display panel is driven by a gate driver. The gate driver sequentially generates a plurality of pulse signals and inputs the pulse signals to the touch panel to activate a plurality of touch scan lines.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device with a touch function, comprising:
a display panel, having a plurality of image scan lines, wherein the image scan lines are respectively activated by a plurality of scan signals generated by a gate driver according to a first time sequence; and
a touch panel, having a plurality of touch scan lines and a plurality of touch sensing lines, wherein the touch scan lines and the touch sensing lines are disposed crossing each other for sensing a touched position, and the gate driver also provides a plurality of touch scan signals respectively to the touch scan lines according to a second time sequence.

2. The display device according to claim 1, wherein the touch scan lines are in a horizontal direction of the display panel, and the touch sensing lines are in a vertical direction of the display panel.

3. The display device according to claim 1 further comprising a controller, wherein the controller is connected to the display panel and the touch panel for obtaining a corresponding position of a touch point on the display panel.

4. The display device according to claim 1, wherein the touch panel has a plurality of touch sensing units, wherein the touch sensing units are arranged as a 2-dimensional (2D) array and are connected to the touch scan lines and the touch sensing lines.

5. The display device according to claim 1, wherein the display panel comprises a thin film transistor (TFT) array.

6. The display device according to claim 1, wherein the display panel is a thin film transistor liquid crystal display (TFT-LCD) panel.

7. The display device according to claim 1, wherein when the touch scan lines are sequentially activated, signals at a plurality of sensing points on the touch scan lines are output through the touch sensing lines.

8. The display device according to claim 1, wherein the gate driver respectively generates the scan signals and the touch scan signals for the display panel and the touch panel.

9. The display device according to claim 1, wherein the gate driver generates the scan signals, and the touch scan signals are sequentially selected from the scan signals and input to the touch scan lines of the touch panel.

10. A display device with a touch function, comprising:
a gate driver, for generating a plurality of pulse signals according to a time sequence;
a display panel, having a plurality of image scan lines, wherein the image scan lines are respectively and sequentially activated by the pulse signals; and
a touch panel, having a plurality of scan sensing lines and a plurality of touch sensing lines, wherein the scan sensing lines and the touch sensing lines are disposed crossing each other, and the scan sensing lines are also activated by the pulse signals.

11. The display device according to claim 10, wherein the gate driver generates the pulse signals and respectively inputs the pulse signals to the display panel and the touch panel.

12. The display device according to claim 10, wherein the gate driver generates the pulse signals for the display panel and sequentially selects and inputs a portion of the pulse signals to the touch panel.

13. The display device according to claim 10 further comprising a controller, wherein the controller is connected to the display panel and the touch panel for obtaining a corresponding position of a touch point on the display panel.

14. A 2D sensing method of a touch panel, wherein the touch panel is stacked with a display panel, and the display panel is driven by a gate driver, the 2D sensing method comprising:
sequentially generating a plurality of pulse signals in the gate driver; and
sequentially inputting the pulse signals to the touch panel to activate a plurality of touch scan lines.

15. The 2D sensing method according to claim 14, wherein the pulse signals generated by the gate driver are respectively input to the display panel and the touch panel.

16. The 2D sensing method according to claim 14, wherein
when the pulse signals generated by the gate driver are input to the display panel, a portion of the pulse signals are sequentially selected and input to the touch panel.

17. The 2D sensing method according to claim 14 further comprising sensing at least one touch signal on the touch scan lines through a plurality of touch sensing lines of the touch panel, so as to determine a touched position of a touch point.

18. The 2D sensing method according to claim 14 further comprising converting the touched position into a corresponding position on the display panel.
